(19) United States
(12) Patent Application Publication
(10) Pub. No.: US 2026/0029655 A1
(43) Pub. Date: Jan. 29, 2026

(54) TOP HAT OPTICAL BEAM SHAPING DEVICE

(71) Applicant: OSELA INC., Montreal (CA)

(72) Inventors: Francis Cayer, Montreal (CA); Alexandre Germain, Montreal (CA); Frederic Monet, Montreal (CA)

(73) Assignee: OSELA INC., Montreal (CA)

(21) Appl. No.: 19/283,132

(22) Filed: Jul. 28, 2025

Related U.S. Application Data
(60) Provisional application No. 63/676,607, filed on Jul. 29, 2024.

(51) Int. Cl. G02B 27/09

(52) U.S. Cl. CPC G02B 27/0927; G02B 27/0988

(57) ABSTRACT

An optical beam shaping device for transforming the spatial profile of a light beam into a top hat profile is provided. The optical beam shaping device includes two main components, both provided across the path of the light beam, in any order: an electrical field corrector and a top hat field mapper. The electrical field corrector is configured to alter the electrical field of the light beam along a transverse axis to convert the initial profile of the light beam into a predetermined mapper-input profile. The top hat field mapper is configured to convert light distribution along the transverse axis from the predetermined mapper-input profile to the top hat profile. In some implementations, the initial profile of the light beam is corrected from its original, non-TEM00 shape to a shape better suited to yield a quality top hat profile through the top hat field mapper.

### TECHNICAL FIELD

The technical field generally relates to beam shaping and more particularly concerns a device providing a light beam having a top hat profile.

### BACKGROUND

Top hat beams are light beams having a generally flat intensity profile along one or more axes transverse to the light propagation axis. FIGS. 1A to 1C (PRIOR ART) show different examples of beam profiles 100 considered as top hat shapes by one skilled in the art. The top hat beam profile 100 generally includes a flat central region 102 and transitional edges 104a, 104b where the light intensity decays to substantially zero on each side. The transitional edges 104a, 104b are steeper as the ratio of the top hat length to the diffracted limit spot size of the input beam increases.

A light beam can have a top hat profile within a certain range over its propagation axis. Top hat beams can be, depending on the application, collimated (FIG. 2A—PRIOR ART), at the focal plane of an imaging lens (FIG. 2B—PRIOR ART) or at any working distance with a required divergence or convergence wavefront in the Z propagation axis (FIG. 2C—PRIOR ART). They can be bidimensional with a square or rectangular shape (FIG. 3A—PRIOR ART), or a circular or elliptical shape (FIG. 3B—PRIOR ART), or one dimensional (see FIG. 3C), forming a line along one axis perpendicular to the propagation axis. Typically, in the near UV-IR spectrum, the top hat dimensions can vary from about a half a micron to tens of millimeters. In the case of a 1D top hats, the thickness axis Y (perpendicular to the Top-Hat axis X) is in general Gaussian and has a minimum dimension of about a quarter of micron at 1/e2 and no technical upper limit other than the clear aperture footprint of the system. Top hat beams are of interest for applications where a uniform power density is preferred, such as for example material processing (welding, 3D printing), microscopy (confocal, fluorescence) and flow metrology (flow cytometry, DNA sequencing).

Top hat beam shaping refers to the action of taking an arbitrary input beam and converting it to a top hat intensity distribution. This is typically done using beam shaping methods that manipulate the electric field of the input beam. Top hat profiles are characterized by their uniformity and efficiency. Uniformity relates to the flatness of the central portion (in some implementations referred to as the region of interest (ROI), see for example FIG. 4—PRIOR ART) and can be quantified, although not limited to, by contrast, peak-to-peak variation or standard deviation measurements. Efficiency relates to the power quantity contained in the ROI compared to that of the input beam and can be expressed as the ratio of the power contain in the ROI to that of the input beam. By way of example, in some instances, high quality top hat profiles can be defined, without limitations, as top hat profiles having at least about 50% efficiency, a standard deviation across the ROI between 0 and 5% and a peak-to-peak variation across the ROI between 0 and 10%. They also tend to have an appreciable depth of field, at least more than along the Gaussian axis. Top hat beams are preferred to Gaussian beams in a variety of circumstances. For instance, the better efficiency of the top hat beam can reduce the power requirements on laser sources, which increases its durability, as well as reduces the risks of photobleaching and photodamaging the targets. The uniformity of the top hat profile mitigates image distortions or false signal acquisition due to a non-uniform power density over an illuminated sample. The later is illustrated in FIG. 5 (PRIOR ART), where grey samples passing through far from the center of a Gaussian beam will be irradiated differently than the black one passing through the central portion. The image will suffer from artefacts that can be difficult to compensate numerically.

A few solutions are known in the art to achieve high quality top hat beams. For example, beam integrators methods rely on splitting the input beam in smaller sub-beams. Sub-beams are then overlapped at the image plane to create a top hat. Diffusers and lenslet arrays are examples of beam integrators, such as for example shown in “Compact Beam Homogenizer Module with Laser-Fabricated Lens-Arrays (Appl. Sci. 2021, 11(3), 1018; https://doi.org/10.3390/app11031018). Other methods rely on redirecting the rays or the wavefront of individual beamlets within the initial beam at the right image positions to convert the input intensity distribution to a top hat profile. Refractive field mapping consists of using curved surfaces as field mappers. Powell, cylindrical or acylindrical lenses and lens systems (combination of many lenses) are examples of refractive field mappers (see . . . ). Diffractive optics can achieve the same results by altering the phase of individual beamlets within the initial beam, which then propagate to a top hat profile at the image plane. Examples of diffractive optics field mappers include multi level diffractive lenses, metalenses and Fresnel lenses. Finally, one can also modulate the input beam intensity by using solely slits or apodization to cut out portions of the input beam.

While these solutions can work to a certain extent, they all have drawbacks. Beam integration does not provide the requested uniformity due to the interference of the overlapping beams. It is also not flexible and hardly customizable due to the high setup charges. Refractive solutions are also limited. Cylindrical and hyperbolic lenses do not offer the required surface shape flexibility to deal with anything else than a perfect TEM00 input laser beam (fundamental mode of Gaussian intensities laser propagation) and, even so, with some limitations. Pseudo-Powell lenses refer to lenses having a similar form to Powell Lenses but used to generate laser lines with less than 2 degrees divergence. Aspheric lenses are limited by manufacturing constraints. Complex designs are simply not manufacturable, and customization may be extremely costly due to the necessity of using grinding and molding processes. Diffractive solutions offer more flexibility in terms of manufacturing possibilities, but each design of the diffractive element is expensive to manufacture, as the diffractive element must be inscribed in glass to withstand sufficient power density. This makes customization to various input beams also very expensive. They also induce higher orders, creating unnecessary power losses. Finally, apodizer and slits both cannot produce uniform and efficient top hat beams at the same time. To offer good uniformity, they must cut-out a lot of power and vice-versa. Slits are also subject to low depth of field and sidelobes due to diffraction effects from the beam truncation.

These limitations led, in most applications, to use pre-manufactured top hat beam shaper designed to be compatible with a TEM00 gaussian beam with specific dimensions. However, most lasers sources, more specifically laser diode sources, do not exhibit this kind of beam, making it impossible to obtain a high-quality top hat.

There remains a need in the art for a beam shaping device providing a top hat beam while alleviating at least some of the drawbacks above.

### SUMMARY

In accordance with one aspect, there is provided an optical beam shaping device for transforming a spatial profile of a light beam along a transverse axis perpendicular to a propagation direction of the light beam from an initial profile into a top hat profile, the optical beam shaping device comprising:
an electrical field corrector configured to alter an electrical field of the light beam along said transverse axis to convert the initial profile of the light beam into a predetermined mapper-input profile; and
a top hat field mapper configured to convert light distribution along said transverse axis from the predetermined mapper-input profile to said top hat profile.

In some implementations, the electrical field corrector is disposed before the top hat field mapper, whereas in others the electrical field corrector is disposed after the top hat field mapper.

In some implementations, the electrical field corrector comprises an apodization filter.

The apodization filter may have a transmission profile along the transverse axis which is maximum over a central portion thereof and smoothly decreasing along at least one outer edge thereof.

The apodization filter may comprises a functional layer having a thickness function h(x) over position x along the transverse axis X providing said transmission profile.

In some implementations, the thickness function is:

$$h ( x ) = 0 , abs ( x ) E [ 0 , K 1 ]$$

$$h ( x ) = ax + b , abs ( x ) E [ K 1 , K 1 + K 2 ]$$

$$h ( x ) = e , abs ( x ) > K 1 + K 2$$

where a, b, e, K1 and K2 are pre-selected constants.

In some implementations, the thickness function is:

$$h ( x ) = 0 , x < K 1$$

$$h ( x ) = ax + b , xE [ K 1 , K 1 + K 2 ]$$

$$h ( x ) = e , x > K 1 + K 2$$

where a, b, e, K1 and K2 are pre-selected constants.

In some implementations, the thickness function is:

$$h ( x ) = e , abs ( x ) E [ 0 , K 1 ]$$

$$h ( x ) = ax + b , abs ( x ) E [ K 1 , K 1 + K 2 ]$$

$$h ( x ) = 0 , abs ( x ) > K 1 + K 2$$

where a, b, e, K1 and K2 are pre-selected constants.

In some implementations, the thickness function is:

$$h ( x ) = e , x < K 1$$

$$h ( x ) = ax + b , xE [ K 1 , K 1 + K 2 ]$$

$$h ( x ) = 0 , x > K 1 + K 2$$

where a, b, e, K1 and K2 are pre-selected constants.

In some implementations, the apodization filter is a variable light apodizer, comprising:
at least one side filter disposed across a path of the light beam, each side filter having a filter transmission profile along the transverse axes which is maximum from a first edge of the light beam up to a transition point within the light beam and gradually decreases from said transition point to a second edge of said light beam; and
a filter-moving assembly comprising at least one mechanical mount having one or more of the at least one side filter being secured thereon, each of the at least one mechanical mount being movable according to a motion shifting the filter transmission profile of the one or more side filter thereon along the transverse axis.

In some implementations, the apodization filter comprises a slit tilted with respect to the transverse axis.

In some implementations, the electrical field corrector comprises a diffractive component.

In some implementations, the electrical field corrector is configured to convert the light beam from a non-TEM00 profile as said initial profile to a TEM00 Gaussian profile as said predetermined mapper-input profile.

In some implementations, the top hat field mapper comprises an acylindrical lens.

In some implementations, the top hat field mapper further comprises an imaging lens.

In some implementations, the electrical field corrector and the top hat field mapper each includes a plurality of subcomponents, the subcomponents of the electrical field mapper being interspersed with the subcomponents of the top hat field mapper.

In some implementations, the electrical field corrector and the top hat field mapper are integrated in a monolithic component.

Other features and advantages will be better understood upon of reading of detailed embodiments with reference to the appended drawings.

### BRIEF DESCRIPTION OF THE DRAWINGS

FIG. 1A, 1B and 1C (PRIOR ART) show different examples of top hat profiles.

FIGS. 2A to 2C show examples of top hat beams that are collimated (FIG. 2A), at the focal plane of an imaging lens (FIG. 2B) and at a working distance with a required divergence or convergence wavefront in the Z propagation axis (FIG. 2C).

FIGS. 3A to 3C (PRIOR ART) are 3D representations of top hat shapes such as square or rectangular (FIG. 3A), circular or elliptical (FIG. 3B), or one dimensional (FIG. 3C).

FIG. 4 (PRIOR ART) illustrates the Region Of Interest (ROI) of a top hat profile.

FIG. 5 (PRIOR ART) illustrates how the uniformity of a top hat profile mitigates image distortions or false signal acquisition compared to a Gaussian beam.

FIGS. 6A to 6E illustrate various examples of initial profiles. FIG. 6A compares a Gaussian profile with a Lorentzian profile and a Voigt input profile; FIG. 6B shows an asymmetric initial profile; FIG. 6C shows an initial profile with intensity aberrations; FIG. 6D shows an initial profile with wavefront aberrations; and FIG. 6E shows an initial profile initial profile with a Gaussian or Gaussian-like central portion accompanied by laser noise features.

FIGS. 7A to 7E (PRIOR ART) show the “top hat” profiles that are typically obtained from the different input beam profiles of FIGS. 6A to 6E, using a prior art shaping technique.

FIG. 8 is a schematized representation of an optical beam shaping device according to one implementation.

FIG. 9 is a cross-section schematized representation of a an apodization filter embodying an electrical field corrector according to one variant.

FIGS. 10A to 10D illustrates different examples of thickness functions for an apodization filter for use as an electrical field corrector according to some embodiments.

FIG. 11 is a schematized representation of a variable apodizer for use as an electrical field corrector according to one embodiment; FIG. 11A shows an example of filter transmission profiles associated with the first and second X-axis side filters of the variable apodizer of FIG. 11; FIGS. 11B and 11C show the resulting transmission function for different levels of apodization.

FIGS. 12, 12A and 12B show an apodization device using a tilted slit as a corrector, respectively view from the propagation axis Z (FIG. 12), the transverse axis X (FIG. 12A) and the uncorrected transverse axis Y (FIG. 12B); FIG. 12 C shows the resulting apodization profile.

FIG. 13A shows the initial profile of the input beam relative the geometry of a diffractive electrical field corrector; FIG. 13B compares an example of the geometry of a diffractive electrical filed corrector to the geometry of a fully diffractive field mapper; FIG. 13C shows a high-quality top hat beam profile obtained from a combination of the diffractive corrector of FIGS. 13A and 13B and a generic top hat field mapper; and FIG. 13D shows an example of a mapper-input profile, defined as the light profile resulting from the correction effect of the electrical field correction on the input profile.

FIG. 14 illustrates the use of an acylindrical lens as the top hat field mapper.

FIG. 15 illustrates an optical beam shaping device configuration in which the input beam is incident on the top hat field mapper before the electrical field corrector.

FIG. 16 illustrate a variant of the optical beam shaping device in which of the electrical field corrector and the top hat field mapper are embedded in a same substrate.

FIG. 17 shows an example of a configuration where the electrical field corrector and the top hat field mapper both include subcomponents interspersed with each other.

FIG. 18, there is shown a variant of the optical beam shaping device in which the electrical field corrector and the top hat field mapper are integrated in a single monolithic component.

FIGS. 19 and 19A show the light beam profile before and after the electrical field corrector based on the thickness profile of FIG. 10A.

### DETAILED DESCRIPTION

In the following description, similar features in the drawings have been given similar reference numerals. In order not to unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

The terms “a”, “an” and “one” are defined herein to mean “at least one”, that is, these terms do not exclude a plural number of items, unless stated otherwise. Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be mechanical, optical, electrical, logical, or any combination thereof.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared or ultraviolet regions of the electromagnetic spectrum. Also, the skilled person will appreciate that the definition of the ultraviolet, visible and infrared ranges in terms of spectral ranges, as well as the dividing lines between them, may vary depending on the technical field or the definitions under consideration, and are not meant to limit the scope of applications of the present techniques.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In the present description, when a broad range of numerical values is provided, any possible narrower range within the boundaries of the broader range is also contemplated.

For example, if a broad range value of from 0 to 1000 is provided, any narrower range between 0 and 1000 is also contemplated. If a broad range value of from 0 to 1 is mentioned, any narrower range between 0 and 1, i.e. with decimal value, is also contemplated.

In accordance with some aspects, there is provided a beam shaping device transforming a spatial profile of a light beam into a top hat profile, therefore providing a top hat beam.

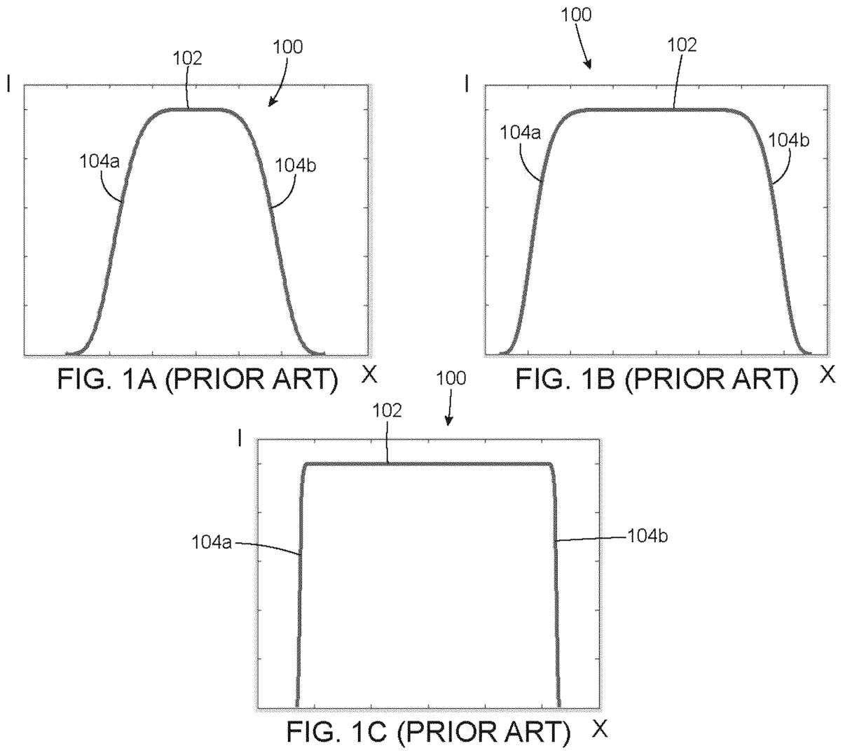

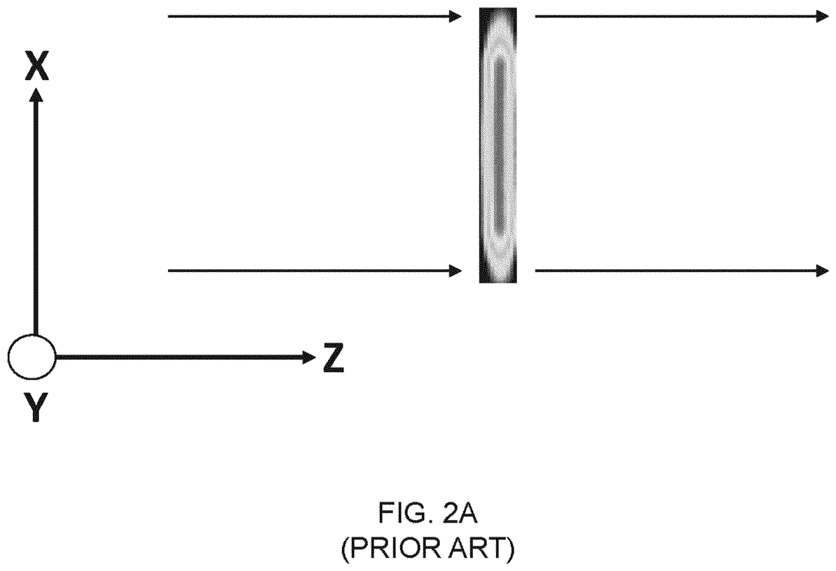

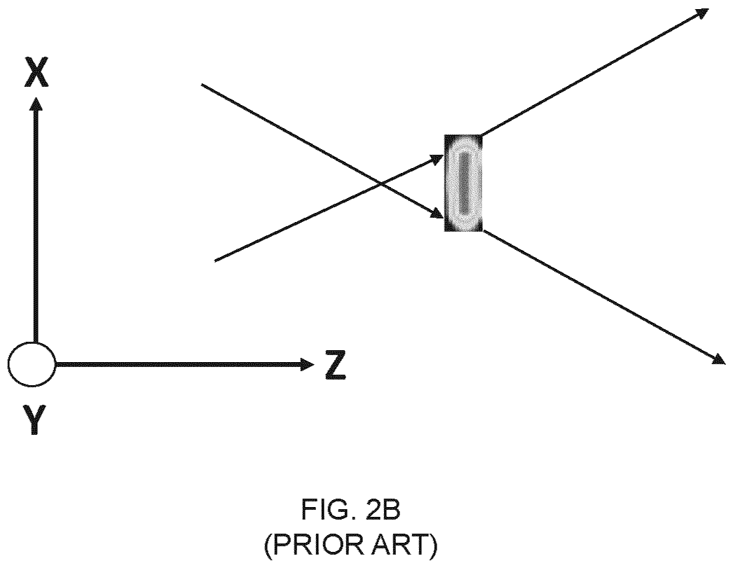

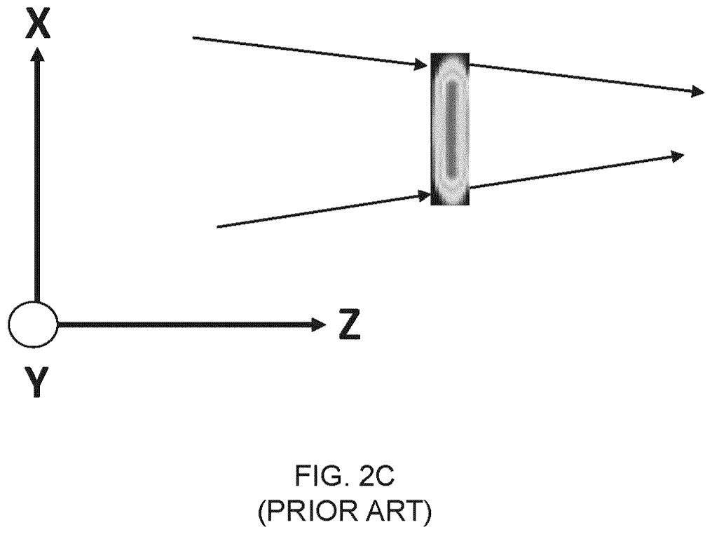

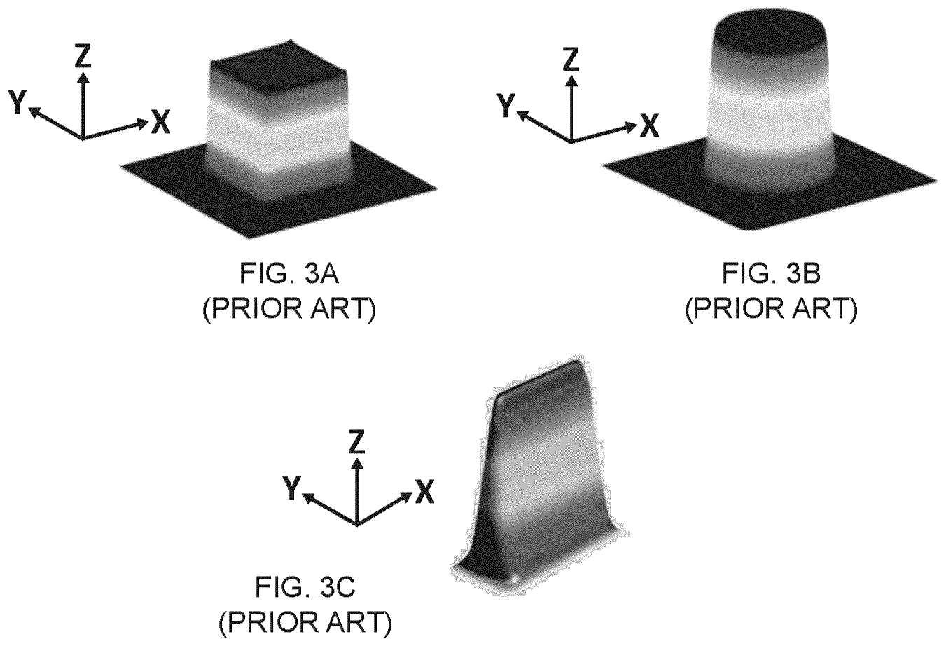

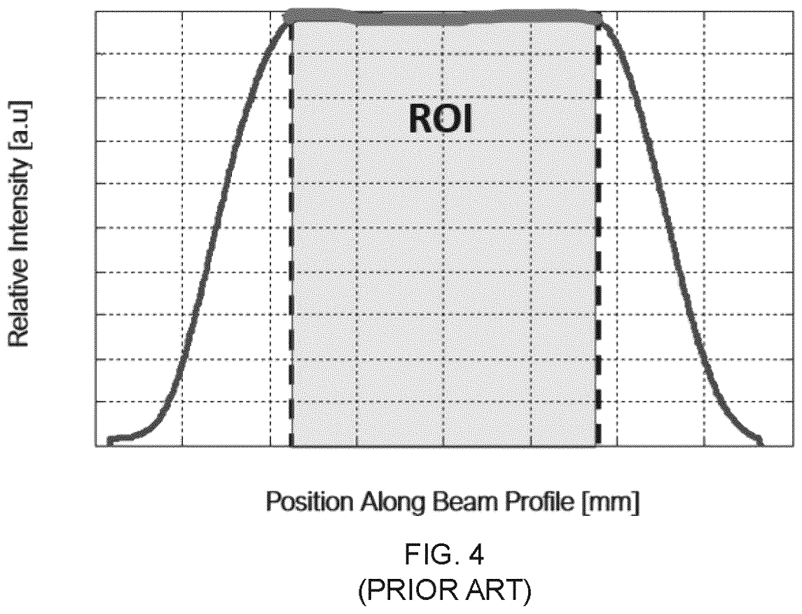

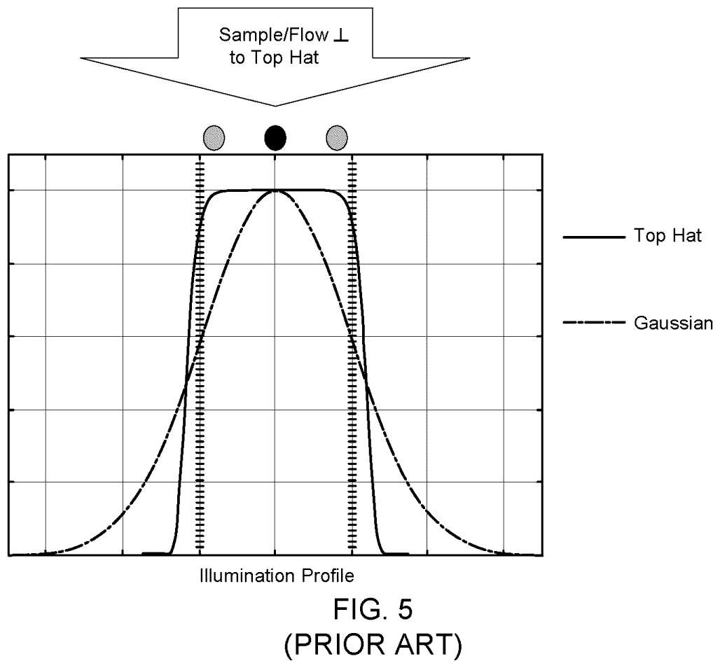

As mentioned above, a top hat beam may be understood as a light beam having a generally flat intensity profile along one or more axes transverse to the light propagation axis, this intensity profile having a shape generally forming a flat central region surrounded on each side by transitional edges in which the light intensity decays. Top hat beams may also be referred to as flat top beams, both expressions being used interchangeably in the art. As known to those skilled in the art, the central region of a top hat beam is considered “flat” by contrast with the typical Gaussian or Gaussian-like intensity profile of light beams generated by typical laser sources but may still include some non-uniformities without departing from the definition of a top hat shape. The transitional edges of the flat top beam may have varying degrees of steepness, such as shown in the examples of FIGS. 1A to 1C.

In some implementations, the optical beam shaping device is configured to transform the spatial profile of a light beam from an initial profile into the top hat profile. It will be readily understood that referral to the spatial profile of the light beam corresponds to the light distribution within the light beam along a transverse axis perpendicular to a propagation direction, by convention designated as the Z axis. In some implementations, the optical beam shaping device may be configured to effect the transformation of the spatial profile of the light beam along a single axis, arbitrarily labelled X in the accompanying figures. In other variants, as described below, the optical beam shaping device may be configured to effect the transformation of the spatial profile of the light beam along two orthogonal axes X and Y.

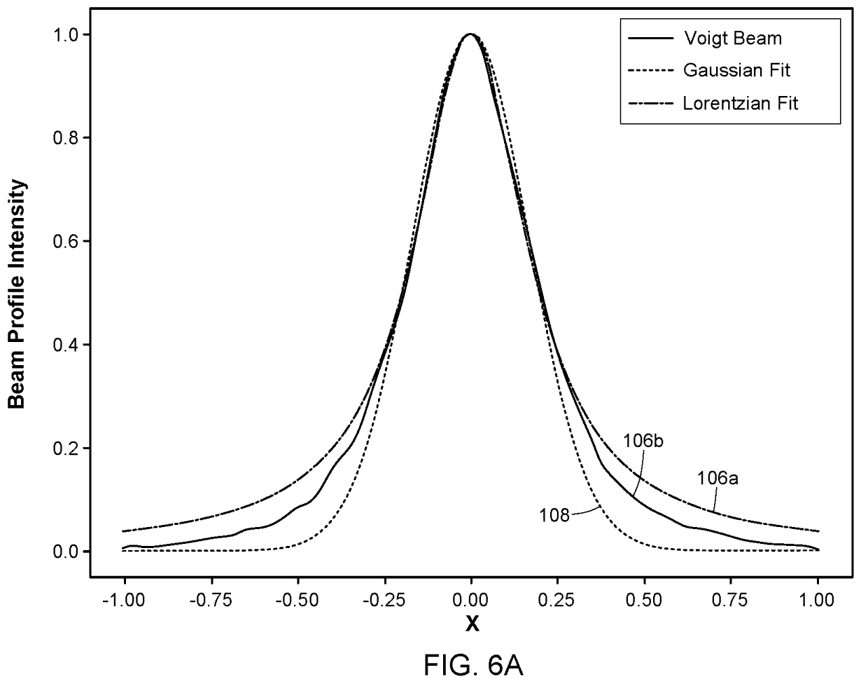

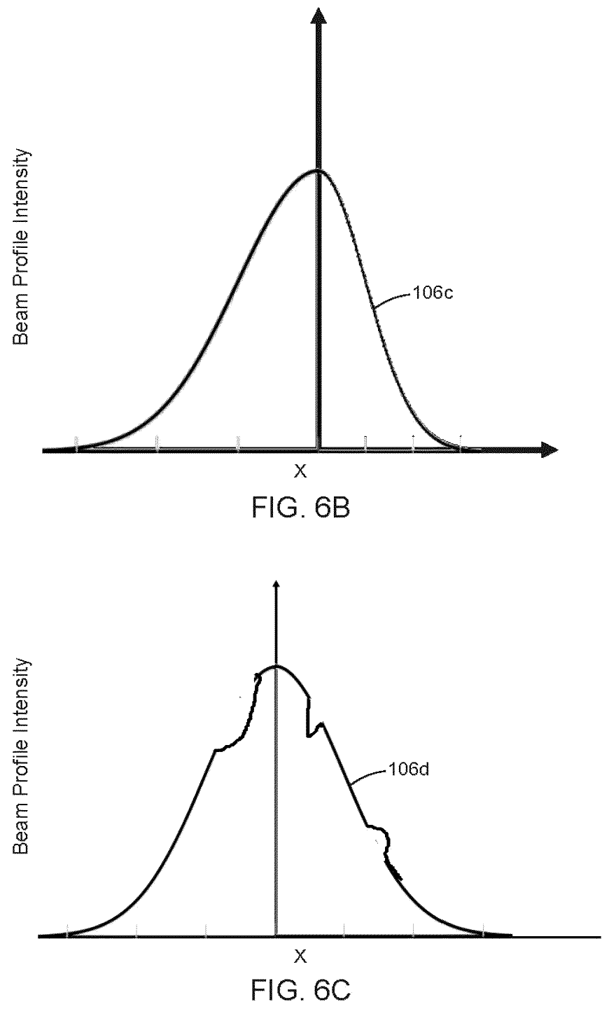

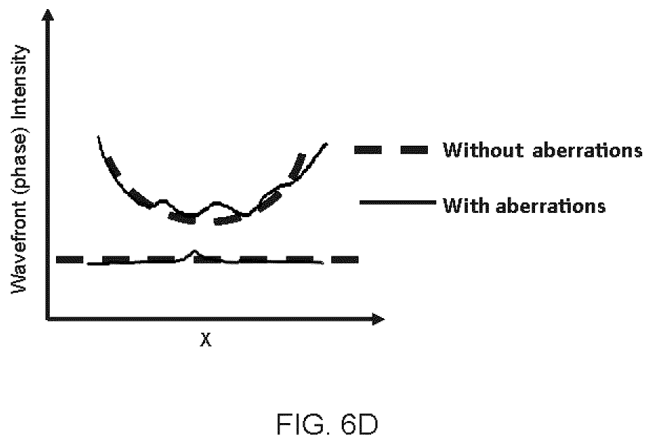

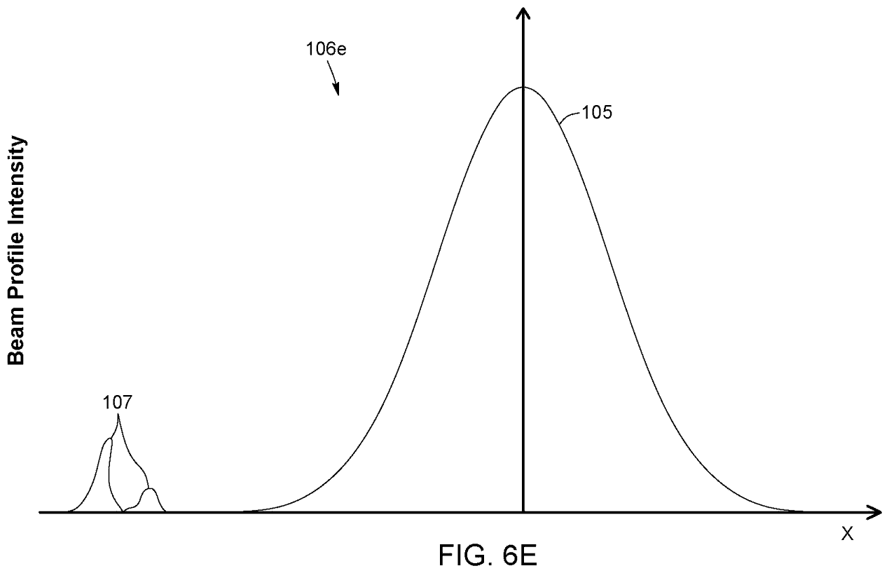

Referring to FIGS. 6A to 6E, according to one aspect, the initial profile 106 of the light beam used as input differs from a strict Gaussian profile 108. Embodiments of the present technology may use as input light beams having a variety of initial profiles. In some implementations the initial profile is a Gaussian-like profile, having a shape reminiscent of a Gaussian, but with slight variations. By way of example, FIG. 6A compares a Gaussian profile 108 with two examples of Gaussian-like profiles, a Lorentzian profile 106a and a Voigt input profile 106b representative of a typical beam having extended tails compared to the Gaussian profile 108. In some implementations, the initial profile may be an asymmetrical profile 106c, an example of which is shown in FIG. 6B. In some variants the initial profile 106d may include intensity aberrations, such as shown in FIG. 6C, or wavefront aberrations, such as shown in FIG. 6D. Referring to FIG. 6E, in other variants, the initial profile 106e of the light beam may have a Gaussian or Gaussian-like central portion 105, accompanied by laser noise features 107 on one or both sides thereof.

In some implementations, the light beam used as input to the optical beam shaping device may originate from a laser light source emitting light which does not correspond to a TEM00 Gaussian beam, and may therefore be referred to as a non-TEM00 input beam. The laser light source may for example be a laser diode, a fiber laser, a DPSS, an OPSL, a VECSEL, an excimer laser, a LED, or the like.

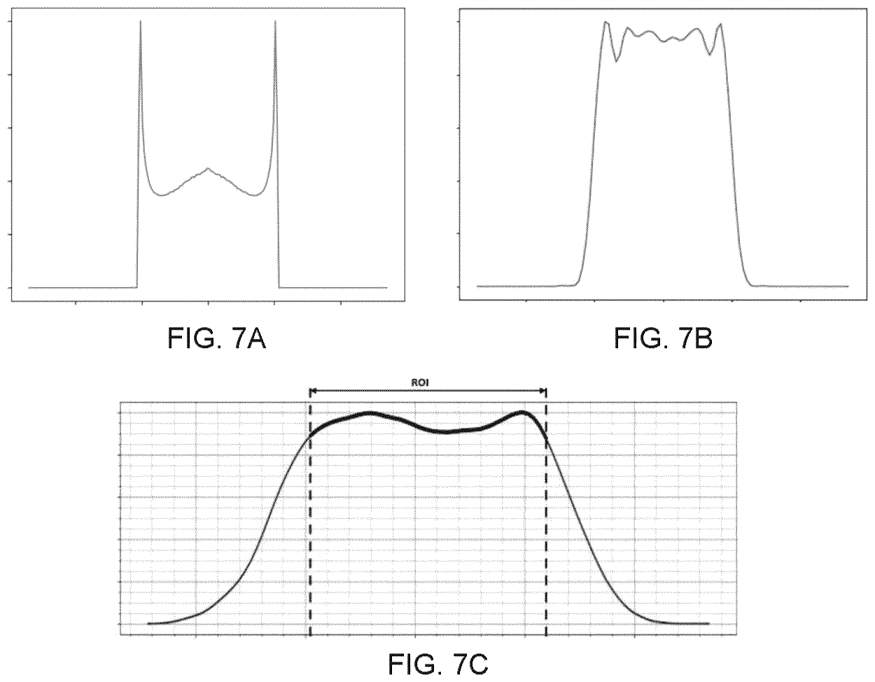

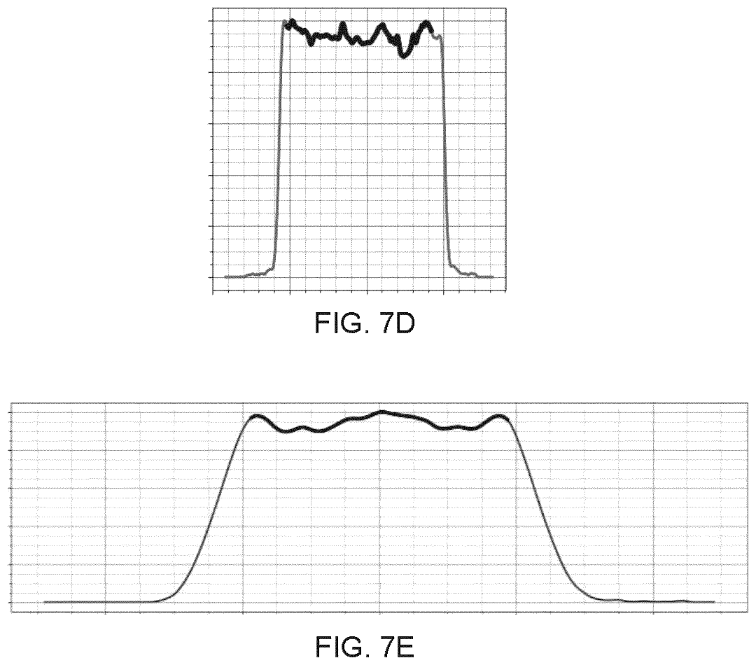

FIGS. 7A to 7E (PRIOR ART) show the “top hat” profiles that are typically obtained from the different input beam profiles of FIGS. 6A to 6E, using a prior art shaping technique such as a Powell lens and certain acylindrical lenses. The illustrated output profiles correspond to the transformation of input beams having respectively a Lorentzian profile (FIG. 7A), a Voigt profile (FIG. 7B), an asymmetrical profile (FIG. 7C), a profile with intensity aberrations (FIG. 7D) and a profile with wavefront aberrations (FIG. 7E). As can be seen, strong deviations from an ideal top hat profile can be observed in either the flat central portion 102, the transitional edges 104a, 104b or both.

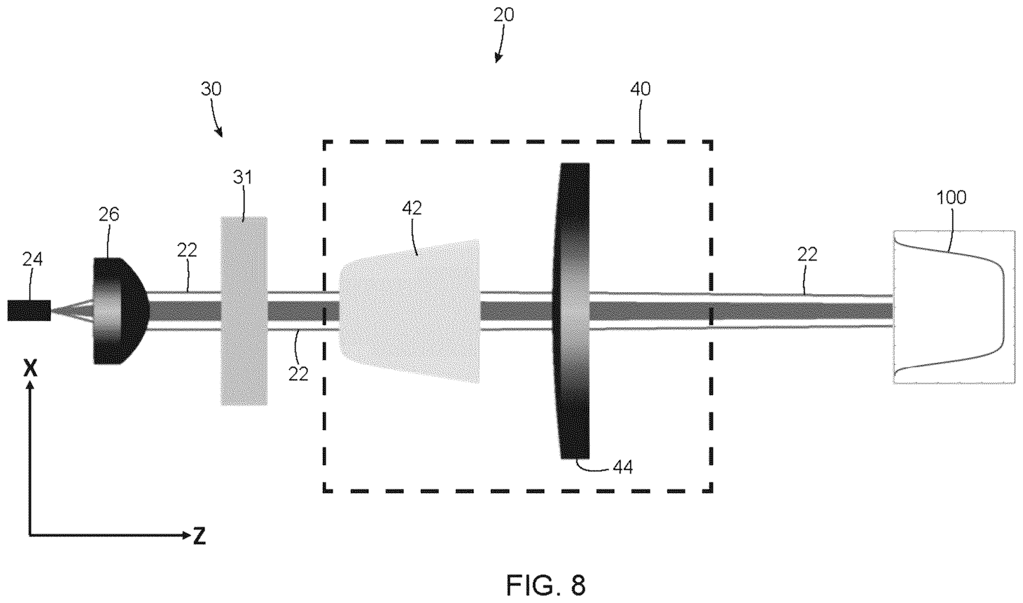

Referring to FIG. 8, there is shown an example of an optical beam shaping device 20 for transforming the spatial profile of a light beam 22 into a top hat profile 100. In the illustrated embodiment, the optical beam shaping device 20 alters the light beam 22 along a single dimension, along the transverse axis X, resulting in a line-shaped output along the X axis. The designation of the transverse axis as the “X axis” is used by convention to designate any axis perpendicular to the propagation of the light beam for ease of reference only. The optical beam shaping device 20 includes two main components, both provided across the path of the light beam 22, in any order: an electrical field corrector 30 and a top hat field mapper 40.

The electrical field corrector 30 is configured to alter the electrical field of the light beam 22 along the transverse axis X to convert the initial profile of the light beam into a predetermined mapper-input profile, as explained below. The top hat field mapper 40 is configured to convert light distribution along the transverse axis X from the predetermined mapper-input profile to the top hat profile. In some implementations, the initial profile of the light beam is corrected from its original, non-TEM00 shape to a shape better suited to yield a quality top hat profile through the top hat field mapper. This correction may be a pre-correction, with the electrical field corrector 30 dispose before the top hat field mapper 40, or a post-correction, with the electrical field corrector 30 disposed after the top hat field mapper 40. In typical implementations the predetermined mapper-input profile may be a TEM00 or Gaussian profile.

In the illustrated embodiment of FIG. 8, the light beam 22 is generated by a light source 24 such as a laser diode, and collimated by an optional aspheric collimator 26, hence resulting in the non-TEM00 input beam 22. In the illustrated variant, the light beam 22 is first incident and transmitted through the electrical field corrector 30. In a 1D setup, the electrical field corrector 30 acts solely on the X axis. The light beam 22 is then incident and transmitted through the top hat field mapper 40. In the illustrated variant, the top hat field mapper 40 includes a top hat lens 42 and an imaging lens 44, both described in more details below. The light beam 22 then propagates up to its working plane or depth of field where a high-quality top hat profile 100 is obtained.

### Electrical Field Corrector

The electrical field corrector 30 may be embodied by any optical component or combination of optical components configured to perform the desired correction of the input profile into the predetermined mapper-input profile. In some implementations, the electrical field corrector 30 is configured to locally shape the electrical field of the light beam such that, neglecting power losses through material and due to reflections, its transfer function F over the transverse axis X may follow the following rules:
F(x)=A(x)*exp(ib(x)), for X position where correction is required
A E [01],
b E R
i=imaginary number

In some implementations, the electrical field corrector 30 may have at least one of the following properties:
At least one region over which F(x)=1;
Each region where F(x)=1 is of finite dimensions (no singularities such as the center point of any refractive lens);
The integrated transmission of F(x) over the light beam is greater than about 90%;
Each local phase-shift correction is at least about 5 times smaller than the maximum phase shift created by the top hat field mapper (for example: if the top hat field mapper induce a maximum of 1) phase shift over the entrance pupil diameter, the corrector maximum local phase shift shall be less than 0.2λ);
Higher orders diffracted light peak intensity are less than about 0.5% of the central order peak intensity.

As will be readily understood by one skilled in the art, the electrical field corrector 30 by itself does not act as top hat shaping device, as it does not transform the input beam into a top hat beam. Rather, it corrects the imperfections created by the mismatch between the top hat field mapper and the input beam. It could also be seen as a corrector of the input beam properties to make it match the top hat field mapper or a sub-section of a top hat field mapper system that enables higher quality top hat and customization with a non TEM00 input beam.

Still referring to FIG. 8, in some implementations, the electrical field corrector 30 may be or may include an apodization filter 31. In the context of the present description, an apodization filter or apodizer may be understood as an optical component that has a transmission profile that filters out light from the tails of the initial profile of the light beam. As mentioned above, although the embodiment of FIG. 8 shows the electrical field corrector 30 embodied by an apodization filter 31 positioned prior to the top hat field mapper 40 along the path of the light beam 22, in typical implementations the position of the electrical field corrector 30 in the optical train is not relevant to its performances, and it could be positioned after or before any other element. The electrical field corrector 30 acts on the same transverse axis (X) as the top hat field mapper 40.

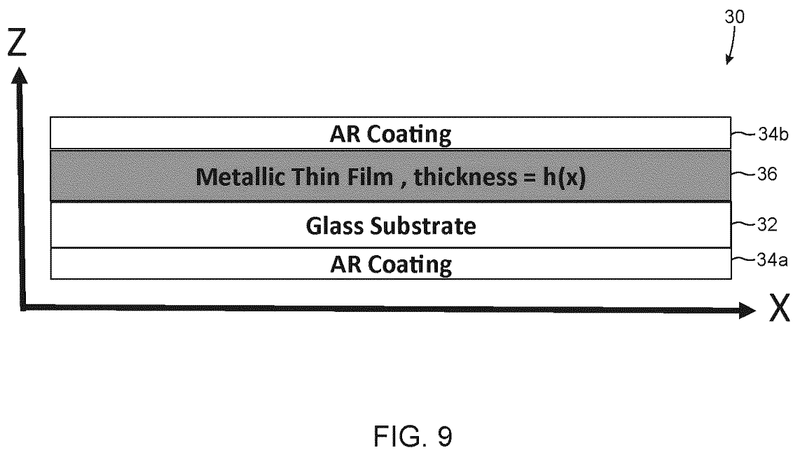

Referring to FIG. 9, there is shown an example of the structure of a monolithic optical element which may embody an apodization filter 31 variant of the electrical field corrector 30. The illustrated structure includes a planar glass substrate 32 on which is provided a thin film metallic deposition 36, sandwiched between inner and outer Anti-Reflection (AR) coatings 34a, 34b. The outer AR coating layer 34b extending over the thin metallic film 36 also acts as a protection for the thin metallic film 36. The thin film metallic deposition 36 defines a functional layer having a light transmission profile varying according to position along the X axis, thereby providing the desired light apodization. The thin metallic film 36 may have a thickness function (h(X)), that respects the conditions above on the transfer function F(x) of the electrical field corrector 30.

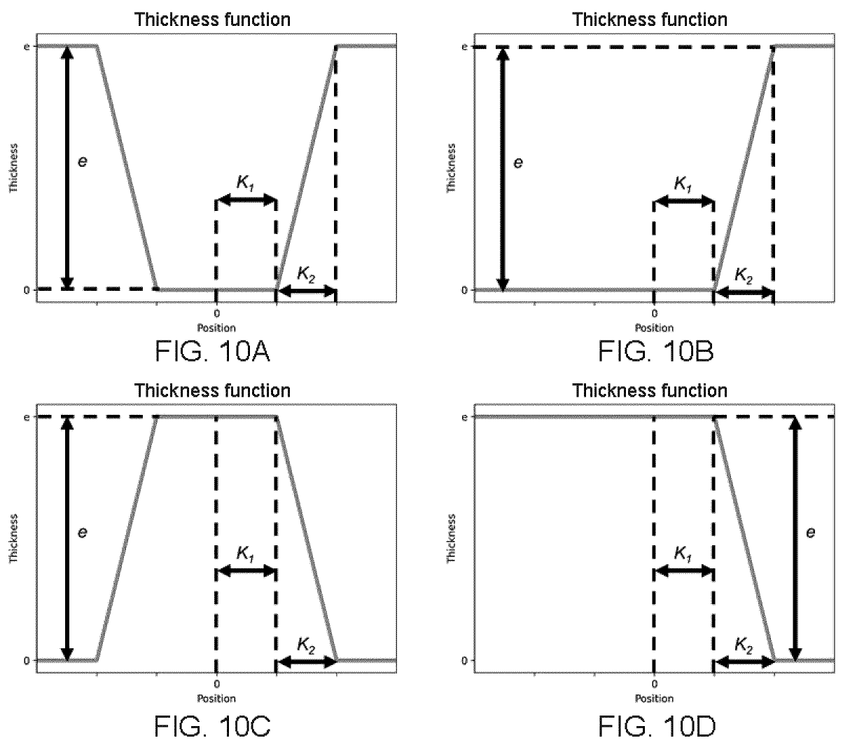

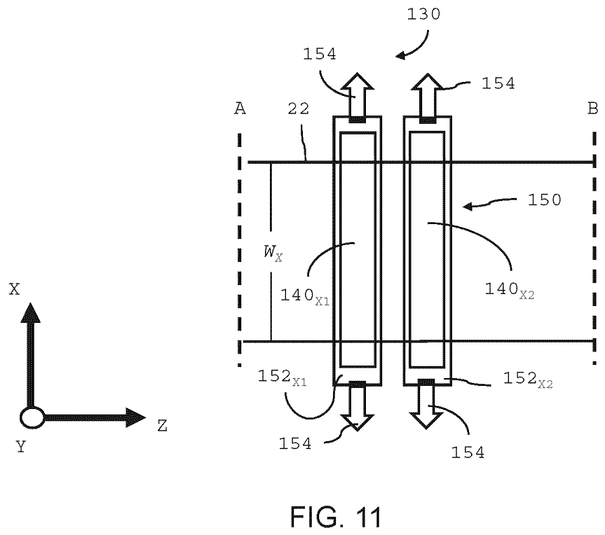

In some implementations, the apodization filter 31 has a transmission profile along the transverse axis X which is maximum over its central portion and smoothly decreasing along its outer edges. In some variants, the transmission profile of the electrical field corrector 30 according to such an embodiment may be designed specifically to solve for a desired reduction of the extended tails (transitional edges) of the input beam 22 and may be based on the following thickness function h(x) of thin metallic film 36 (or other component of the apodization filter providing a variable transmission or reflection of light), illustrated in FIG. 10A:

$$h ( x ) = 0 , abs ( x ) E [ 0 , K 1 ]$$

$$h ( x ) = ax + b , abs ( x ) E [ K 1 , K 1 + K 2 ]$$

$$h ( x ) = e , abs ( x ) > K 1 + K 2$$

Where a, b, e, K1 and K2 are pre-selected constants.

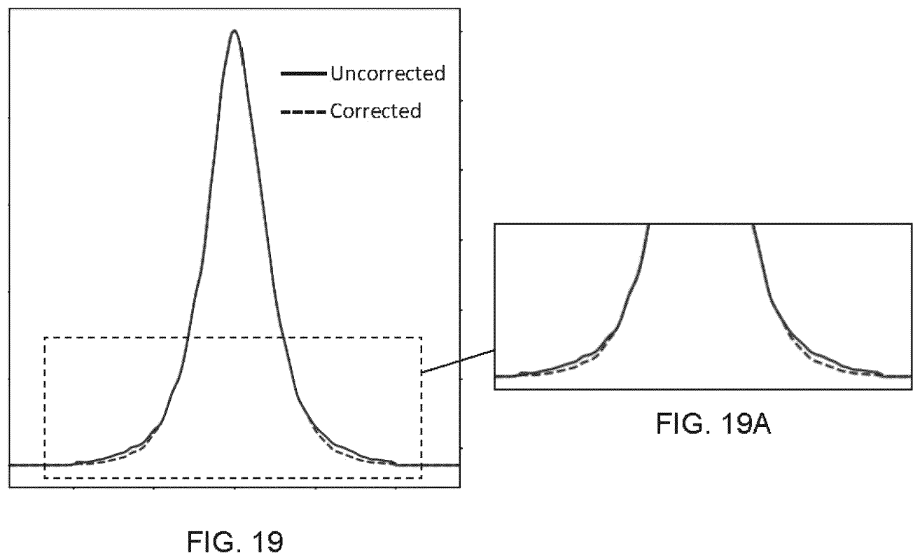

FIGS. 19 and 19A show the light beam profile before and after the electrical field corrector based on the thickness profile of FIG. 10A.

In other cases (see FIG. 10B), the thickness profile may have the following profile:

$$h ( x ) = 0 , x < K 1$$

$$h ( x ) = ax + b , xE [ K 1 , K 1 + K 2 ]$$

$$h ( x ) = e , x > K 1 + K 2$$

### or (see FIG. 10C):

$$h ( x ) = e , abs ( x ) E [ 0 , K 1 ]$$

$$h ( x ) = ax + b , abs ( x ) E [ K 1 , K 1 + K 2 ]$$

$$h ( x ) = 0 , abs ( x ) > K 1 + K 2$$

### or (see FIG. 10D):

$$h ( x ) = e , x < K 1$$

$$h ( x ) = ax + b , xE [ K 1 , K 1 + K 2 ]$$

$$h ( x ) = 0 , x > K 1 + K 2$$

Some of these formulations implies a symmetry that is not always required. In non-symmetrical embodiments, positive X axis values may be driven by K1 and K2 while negative X axis values may be driven by different constant values K1′ and K2′.

The number of possible thickness functions h (x) and corresponding transmission profiles is as high as the number of ways a beam can deviate from a TEM00 Gaussian beam, hence is almost infinite. In some variants, the thickness function (h(x) may have a different form than in the linear examples given above. By way of example, the thickness function h(x) may have an exponential form, a polynomial form, or multiple others.

In some implementations, the apodization filter may be embodied by or include a variable light apodizer, providing a level of apodization of the light beam which can be easily adapted to the properties of the light beam.

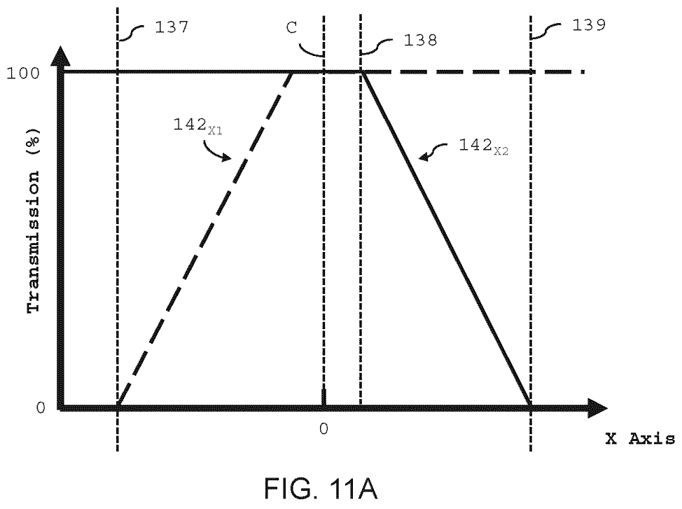

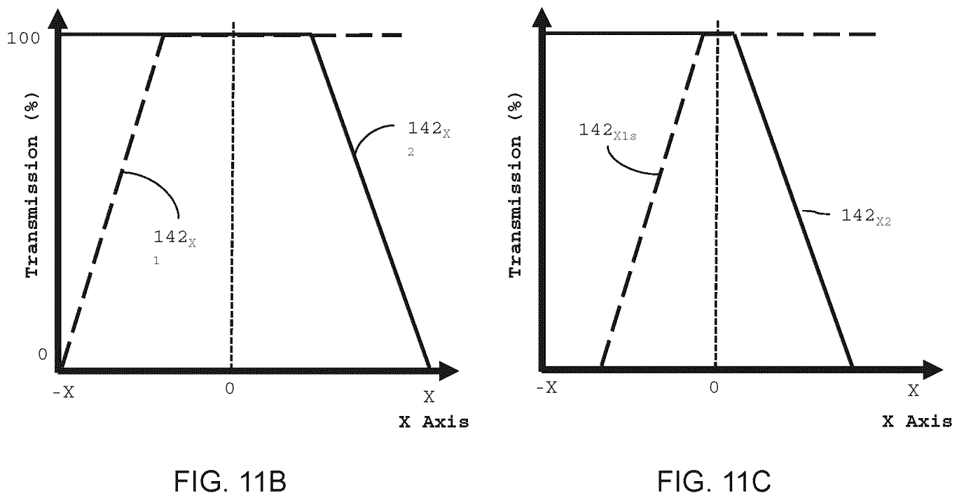

Referring to FIG. 11, a variable light apodizer 130 according to one embodiment is schematically illustrated. The variable light apodizer 130 includes at least one side filter 140 disposed across a path of the light beam 22. In the variant of FIG. 11, two side filters are provided, referred to herein as the first X-axis side filter 140_{X1} and a second X-axis side filter 140_{X2}. Each side filter preferably extends in the X-Y plane. The light beam 22 is understood as propagating along the Z direction and having a transversal spatial profile in the X-Y plane. The light beam 22 may have any dimensions commensurate with the size of the side filters 140. In the example of FIG. 11, the light beam 22 is collimated and has a transverse width w_{X} at the entrance of the first X-side filter 140_{X1}. Each side filter 140 has a filter transmission profile along the transverse axis X, as seen by the light beam when impinging thereon. Referring to FIG. 11A, there is shown an example of filter transmission profiles 142_{X1}, 142_{X2} which may be associated with the first and second X-axis side filters 140_{X1}, 140_{X2} of FIG. 11. The filter transmission profile 142 of each side filter is maximum from a first edge 137 of the light beam up to a transition point 138, preferably past a center point C of the light beam, and gradually decreases from this transition point 138 to a second edge 139 of the light beam 22. In some implementations, each side filter may be embodied by partial transmission optic in such a way that the transmission is maximal at its center and toward one of the extremities of the filter. Toward the other extremity, transmission gradually decreases to 0% with a continuous or non-continuous function that depends on the properties of the side filter.

Referring back to FIG. 11, the variable light apodizer 130 further includes a filter-moving assembly 150. The filter-moving assembly 150 includes at least one mechanical mount 152 having one or more of the side filters 140 being secured thereon. In the example of FIG. 11, the filter-moving assembly 150 includes a first X-axis mechanical mount 152_{X1} on which the first X-axis side filter 140_{X1} is secured, and a second X-axis mechanical mount 152_{X2} on which the second X-axis side filter 140_{X2} is secured. Each mechanical mount 152 is movable according to a motion 154 shifting the filter transmission profile of the side filter 140 thereon along the corresponding transverse axis. Referring again to the example of FIG. 11, both the first and second X-axis mechanical mounts 152_{X1} and 152_{X2} are translation mounts, and the corresponding motion 154 is a translation in either direction along the X axis.

As will be readily understood by one skilled in the art, the motion 154 of the side filters provides a variable apodization of an edge portion of the light beam 22 along the transverse axis X. Each of the side filters 140_{X1} and 140_{X2} can be translated until the beam dimensions at an input plane A is apodized and achieves target specifications at an output plane B. Examples of the resulting transmission function for different levels of apodization are shown in FIGS. 11B and 11C.

The variable light apodizer may be embodied by a variety of components and configurations providing the desired adjustable transmission profile. Further examples of variable apodizer are shown in U.S. provisional patent application 63/698,827 filed on Sep. 25, 2024, the entire contents thereof being incorporated herewith by reference.

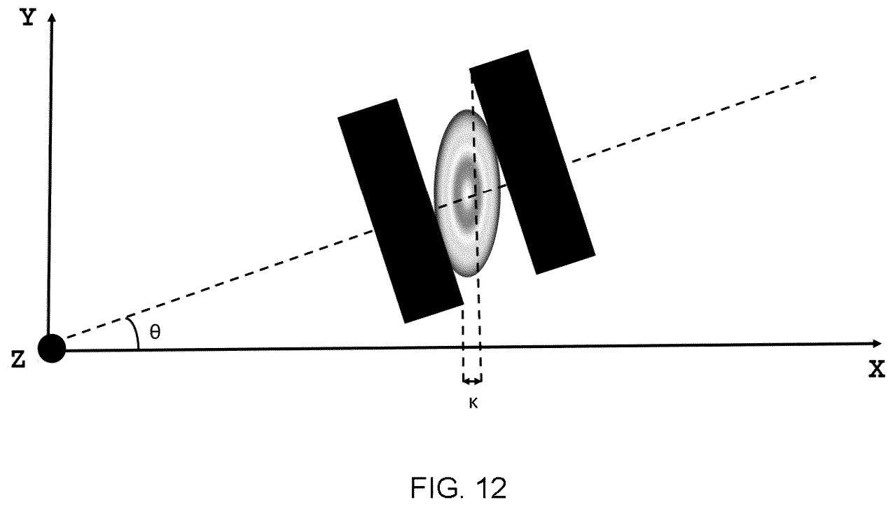

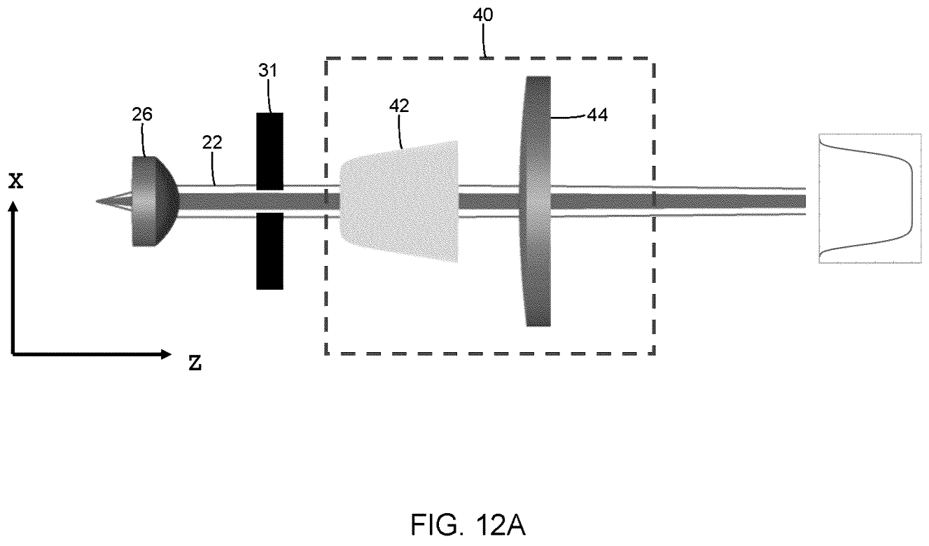

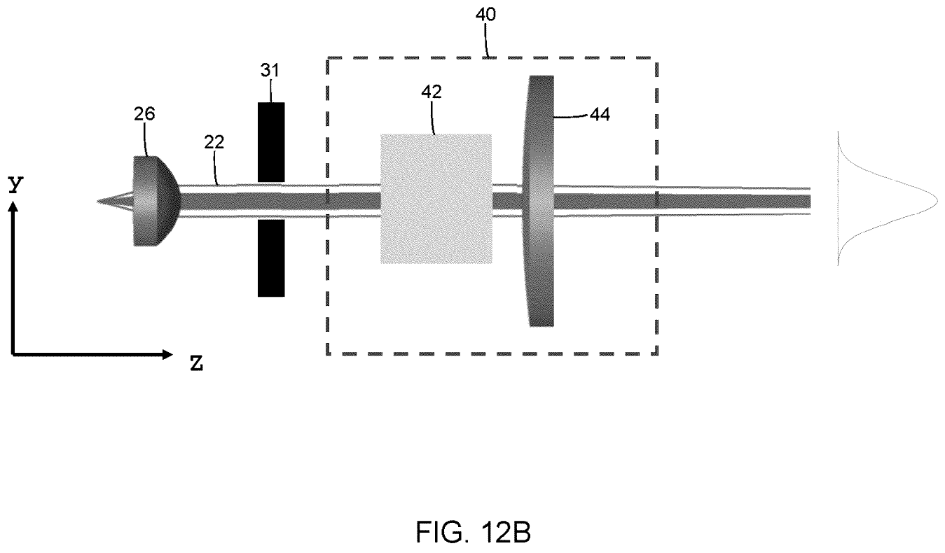

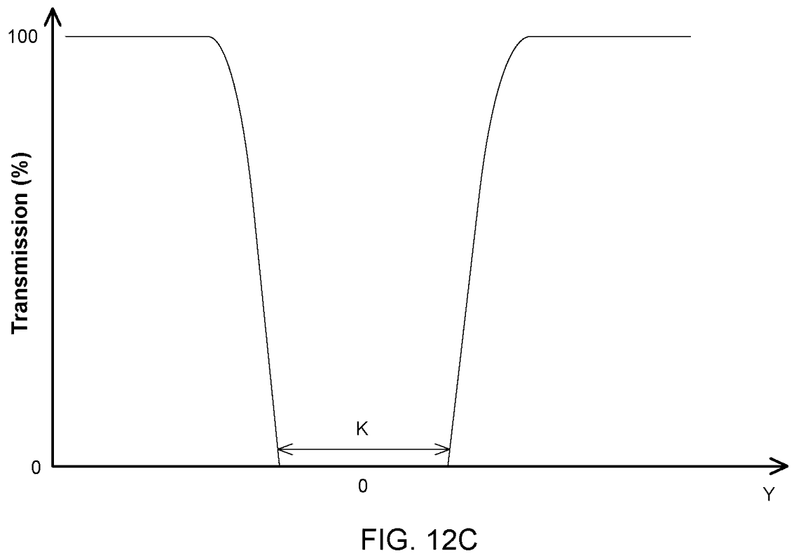

Referring to FIGS. 12, 12A, 12B and 12C in yet another variant, the apodization filter 31 may be embodied by a slit tilted at an angle e with respect to the transverse axis X. By way of example, the slit may have a rectangular-shaped opening having a slit width slightly smaller than a transverse width w_{X} of the light beam 22 at the entrance of the slit 31. The net effect of the slit is to block a portion of the light in the outer edges of the light beam 22, as seen in FIGS. 12 and 12A, leading to an apodization of the light beam along the transverse axis (see FIG. 12C). In the illustrated variant, as seen in FIGS. 12 and 12B, the effect of the slit 31 along the Y axis is negligeable in this case, such that the top hat shape is obtained only along the Y axis. In other variants, the shape of the slit may be adapted to provide the desired apodization along either or both of the transverse axes X and Y.

In an alternate variant, the electrical field corrector 30 may be embodied by or may include a diffractive component, modifying the phase of the light beam as opposed to its intensity such as in the apodization variants above. In one example, diffractive component may be a multilevel diffraction grating. The geometry of the diffraction grating may be optimised by numerical simulation. In some implementations, if the design of the diffraction grating meets the requirements of the Transfer Function (F(x)) described previously, a diffractive electrical field corrector may be faster to customize and manufacture when compared with a fully diffractive beam shaping device, and may not be subject to higher order diffractive light with peak intensity more than 0.5% of the central order peak intensity.

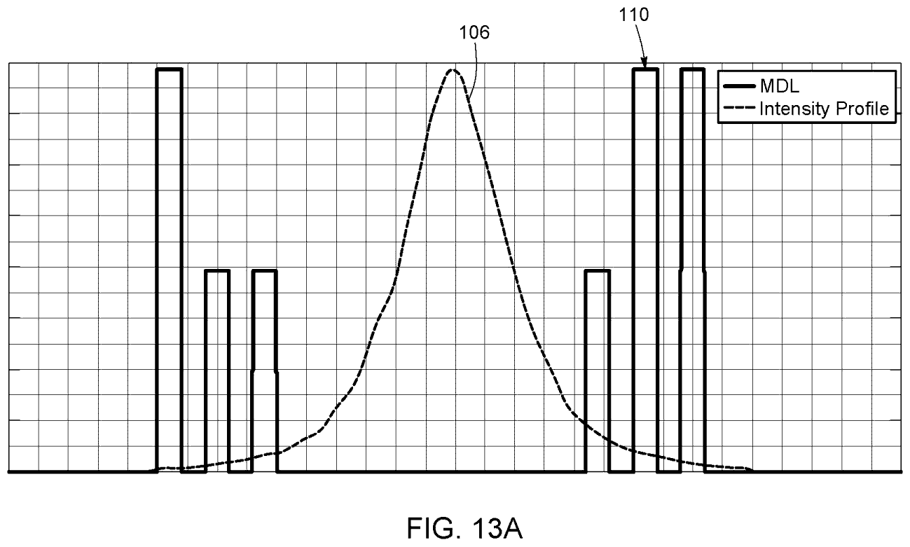

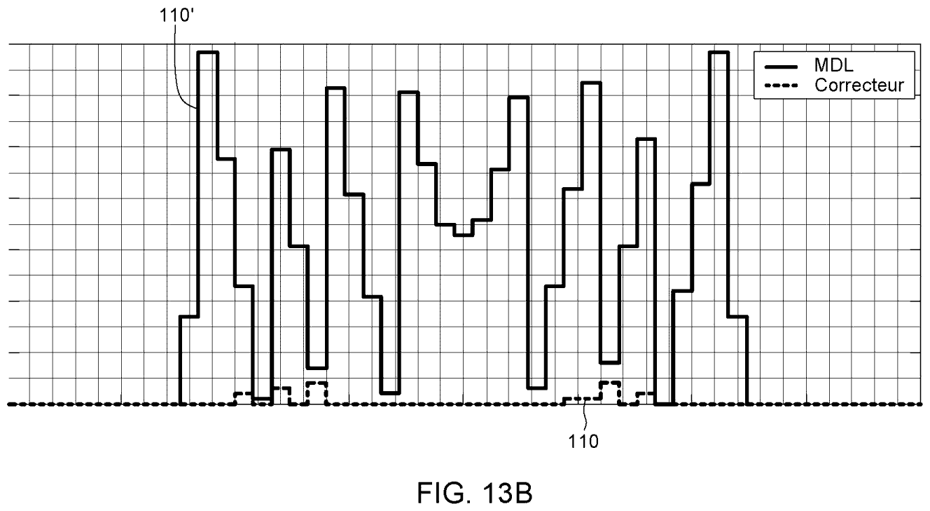

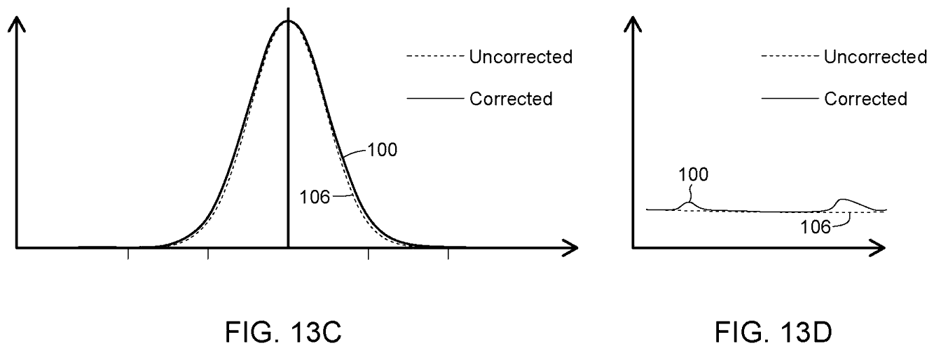

The resulting profile of a diffractive-based electrical field corrector is shown in FIGS. 13A to 13C. FIG. 13A shows the initial profile 106 of the input beam relative the to diffractive corrector geometry 110. FIG. 13B compares the diffractive corrector geometry 110, designed to be coupled with a generic top hat field mapper, to the geometry of a fully diffractive field mapper 110′. The fully diffractive field mapper has more grooves and more depth to be engraved and would suffer from high order diffracted light. FIG. 13C shows a high-quality top hat beam profile 100 obtained from a combination of the diffractive corrector of FIGS. 13A and 13B and a generic top hat field mapper. FIG. 13D shows an example of the mapper-input profile, defined as the light profile resulting from the correction effect of the electrical field correction on the input profile 106. As will be observed, in this variant the intensity of the light beam is not affected by the corrector, only its phase. In other variants, the electrical field corrector may affect both the intensity and the phase of the light beam.

As may be readily understood by one skilled in the art, in some variants, such as cases where the electrical field corrector is disposed after the top hat field mapper, the light beam may not exhibit the mapper-input profile at any point during its transformation.

### Top Hat Field Mapper

As mentioned above, the top hat field mapper is configured to convert light distribution along the transverse axis X from the predetermined mapper-input profile to the top hat profile. In some implementations, the predetermined mapper-input profile may be a TEM00 Gaussian profile, that is, the top hat field mapper is configured to convert a Gaussian beam input a top hat beam.

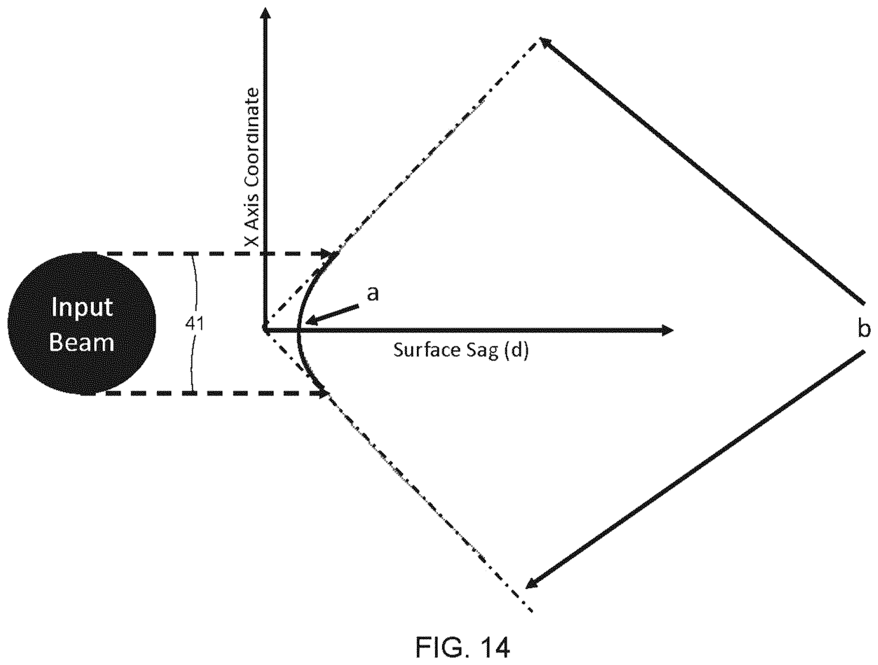

Referring back to FIG. 8, in some implementations, the top hat field mapper 40 may include an acylindrical lens. As known in the art, an acylindrical lenses is typically understood as an optical element that have a generally cylindrical shape with a non-constant radius of curvature. By way of example, the top hat lens 42 shown in the embodiment of FIG. 8 may be such an acylindrical lens. With reference to FIG. 14, In some variants, the acylindrical lens 42 may create a wavefront that, from an optic element surface cross section point of view, has the following properties:
Acylindrical over the input beam region 41;
No inflexion points over the lenses clear aperture (CA)
Local maximum a at the apex, near the center of the input beam region 41;
Tends to a hyperbolic shape at it reaches the optic CA limit b; the surface can be virtually prolonged as straight lines for X→∞.

Advantageously, an acylindrical lens having these properties is typically easily manufacturable and customizable. In other implementations, a cylindrical lens may be used.

In implementations wherein a top hat profile is desired along both transverse axes X and Y, the top hat field mapper may include an aspherical lens having a surface cross-section as explained above in both the X and Y directions. In another example, an optical element having an input surface providing the desired correction in one of the X and Y axes and an output surface providing the desired correction along the other one of the X and Y axes may be envisioned. In yet another example, the top hat field mapper may include two different components respectively acting in the X and Y directions.

In some implementations, such as mentioned above and also shown in the embodiment of FIG. 8, the top hat field mapper 40 may further include an imaging lens 44, which may be selected and disposed to obtain the top hat profile 100 at the focal plane of the imaging lens 44. Depending on the application requirements, the imaging lens 44 may consist of, without limitations, of a plano concave lens, a doublet lens, an achromatic lens, an aspheric lens, a bi-convex lens, a diffracted limited objective, or the like.

In other implementations, the top hat field mapper may be embodied by a diffractive optical element, such as a Multilevel Diffractive Lens (MDL) or a Fresnel Lens. Advantageously, these components may be generic elements less expensive to manufacture than customized versions, as the electrical field corrector alters the light beam into the predetermined mapper-input profile which can be a Gaussian profile or other generic profile.

In some implementations, the top hat field mapper 40 is not subject to higher order diffractive light with peak intensity more than 0.5% of the central order peak intensity.

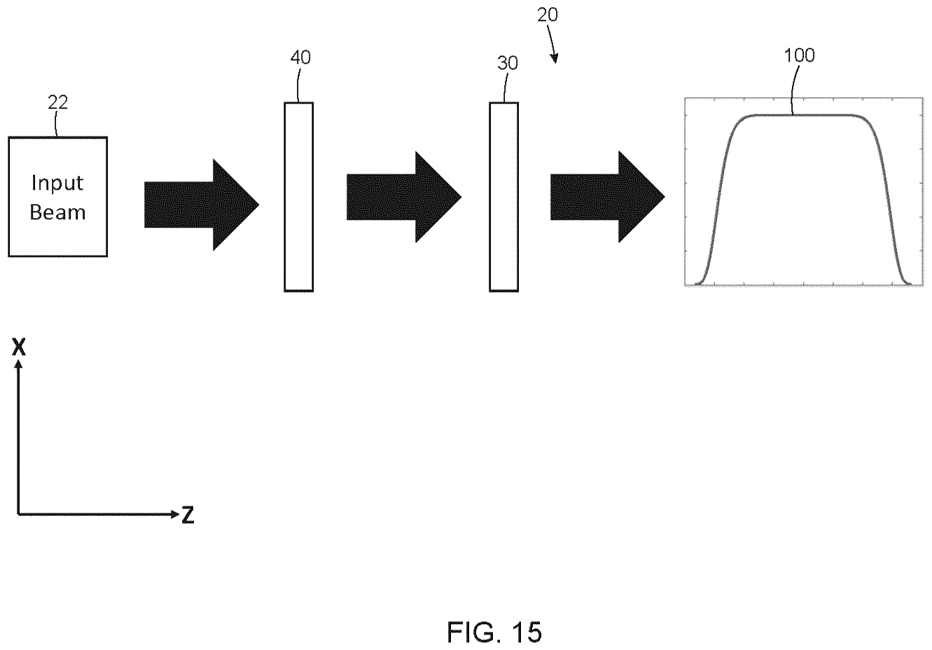

One of ordinary skill in the art can easily imagine that the components of the optical beam shaping device described herein may be assembled in many other ways. FIGS. 15 to 18 illustrate, without limitations, examples of configurations of the optical beam shaping device 20.

FIG. 15 illustrates an optical beam shaping device 20 in which the input beam 22 is incident on and passes through the top hat field mapper 40, and then the electrical field corrector 30, creating a high-quality top hat profile 100. The resulting shape of the top hat profile is independent of the order in which the electrical field corrector and the top hat field mapper are presented. The optical beam shaping device may act either on the X (as illustrated) or the Y axis, or on both at the same time. It could also have a radial symmetry (axisymmetric relative to Z propagation) or radial symmetry but with a certain aspect ratio (elliptic Top Hat).

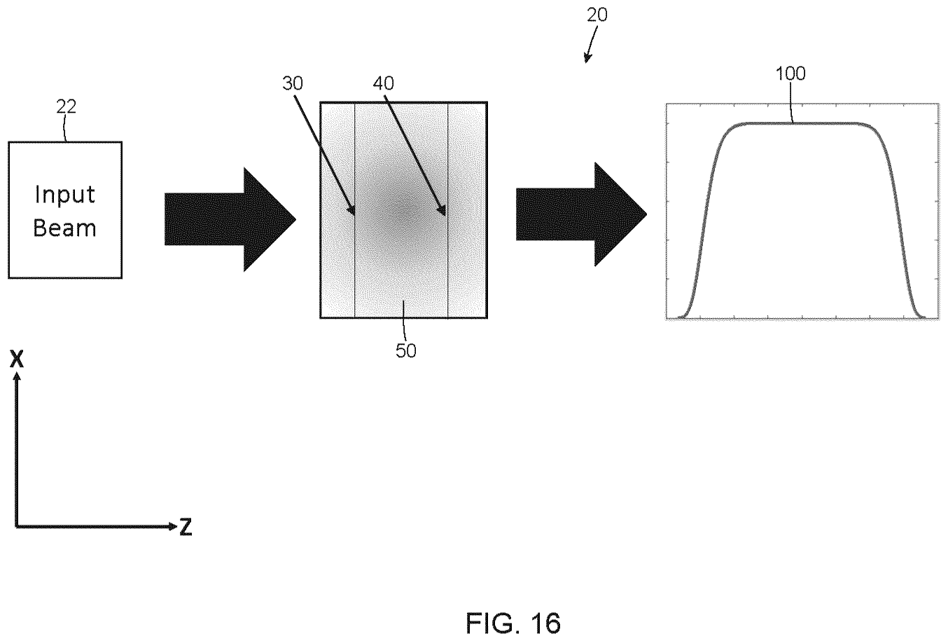

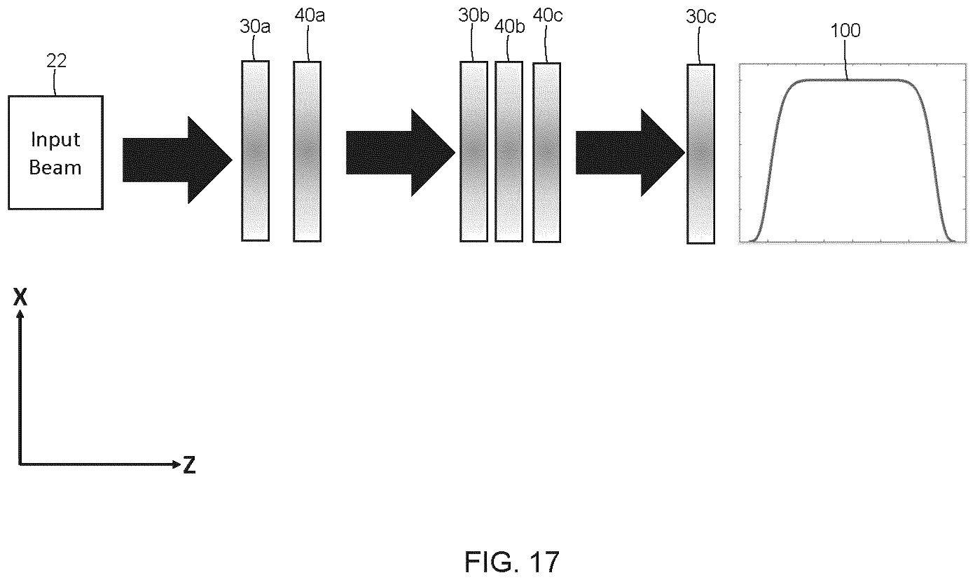

FIG. 16 illustrate a variant of the optical beam shaping device comprising a substrate 50 one or both of the electrical field corrector 30 and the top hat field mapper 40 being embedded in this substrate 50. By way of example, the embedded components may be cemented on the substrate 50 or may be a volumetric grating.

In some embodiments, the electrical field corrector, the top hat field mapper or both may be monolithic or split into multiple component components. Both would not require to be in the same condition (monolithic or many components) and the order of all sub-components would depend on the configuration. By way of example, FIG. 17 shows an example of a configuration where the electrical field corrector and the top hat field mapper both include three subcomponents 30a, 30b, 30c and 40a, 40b, 40c, 40d interspersed with each other.

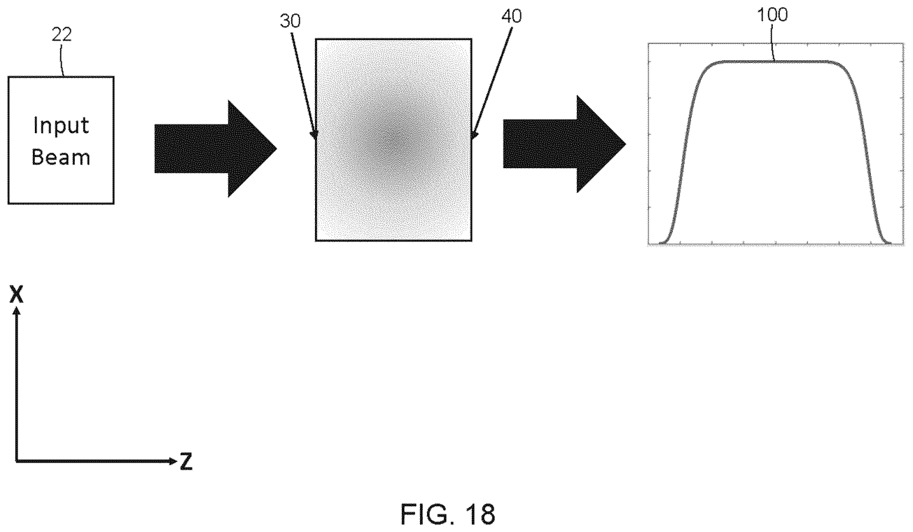

Referring to FIG. 18, there is shown a variant wherein the electrical field corrector 30 and the top hat field mapper 40 are integrated in a single monolithic component. Note that both faces could be switch with the other without consequences.

Finally, all these configurations could be done 1D, 2D (square, rectangle, circular, elliptic) and one skilled in the art will readily devise other ways to package a similar high-quality Top Hat system using the principles explained herein.

Of course, numerous additional modifications could be made to the embodiments described above without departing from the scope of protection as defined in the appended claims.

1. An optical beam shaping device for transforming a spatial profile of a light beam along a transverse axis perpendicular to a propagation direction of the light beam from an initial profile into a top hat profile, the optical beam shaping device comprising:
an electrical field corrector configured to alter an electrical field of the light beam along said transverse axis to convert the initial profile of the light beam into a predetermined mapper-input profile; and
a top hat field mapper configured to convert light distribution along said transverse axis from the predetermined mapper-input profile to said top hat profile.

2. The optical beam shaping device according to claim 1, wherein the electrical field corrector is disposed before the top hat field mapper.

3. The optical beam shaping device according to claim 1, wherein the electrical field corrector is disposed after the top hat field mapper.

4. The optical beam shaping device according to claim 1, wherein the electrical field corrector comprises an apodization filter.

5. The optical beam shaping device according to claim 4, wherein said apodization filter has a transmission profile along the transverse axis which is maximum over a central portion thereof and smoothly decreasing along at least one outer edge thereof.

6. The optical beam shaping device according to claim 4, wherein the apodization filter comprises a functional layer having a thickness function h(x) over position x along the transverse axis X providing said transmission profile.

7. The optical beam shaping device according to claim 6, wherein the thickness function is:
$$h ( x ) = 0 , abs ( x ) E [ 0 , K 1 ]$$
$$h ( x ) = ax + b , abs ( x ) E [ K 1 , K 1 + K 2 ]$$
$$h ( x ) = e , abs ( x ) > K 1 + K 2$$
where a, b, e, K1 and K2 are pre-selected constants.

8. The optical beam shaping device according to claim 6, wherein the thickness function is:
$$h ( x ) = 0 , x < K 1$$
$$h ( x ) = ax + b , xE [ K 1 , K 1 + K 2 ]$$
$$h ( x ) = e , x > K 1 + K 2$$
where a, b, e, K1 and K2 are pre-selected constants.

9. The optical beam shaping device according to claim 6, wherein the thickness function is:
$$h ( x ) = e , abs ( x ) E [ 0 , K 1 ]$$
$$h ( x ) = ax + b , abs ( x ) E [ K 1 , K 1 + K 2 ]$$
$$h ( x ) = 0 , abs ( x ) > K 1 + K 2$$
where a, b, e, K1 and K2 are pre-selected constants.

10. The optical beam shaping device according to claim 6, wherein the thickness function is:
$$h ( x ) = e , x < K 1$$
$$h ( x ) = ax + b , xE [ K 1 , K 1 + K 2 ]$$
$$h ( x ) = 0 , x > K 1 + K 2$$
where a, b, e, K1 and K2 are pre-selected constants.

11. The optical beam shaping device according to claim 4, wherein the apodization filter is a variable light apodizer, comprising:
at least one side filter disposed across a path of the light beam, each side filter having a filter transmission profile along the transverse axes which is maximum from a first edge of the light beam up to a transition point within the light beam and gradually decreases from said transition point to a second edge of said light beam; and
a filter-moving assembly comprising at least one mechanical mount having one or more of the at least one side filter being secured thereon, each of the at least one mechanical mount being movable according to a motion shifting the filter transmission profile of the one or more side filter thereon along the transverse axis.

12. The optical beam shaping device according to claim 4, wherein the apodization filter comprises a slit tilted with respect to the transverse axis.

13. The optical beam shaping device according to claim 1, wherein the electrical field corrector comprises a diffractive component.

14. The optical beam shaping device according to claim 1, wherein the electrical field corrector is configured to convert the light beam from a non-TEM00 profile as said initial profile to a TEM00 Gaussian profile as said predetermined mapper-input profile.

15. The optical beam shaping device according to claim 1, wherein the top hat field mapper comprises an acylindrical lens.

16. The optical beam shaping device according to claim 15, wherein the top hat field mapper further comprises an imaging lens.

17. The optical beam shaping device according to claim 1, wherein the electrical field corrector and the top hat field mapper each includes a plurality of subcomponents, the subcomponents of the electrical field mapper being interspersed with the subcomponents of the top hat field mapper.

18. The optical beam shaping device according to claim 1, wherein the electrical field corrector and the top hat field mapper are integrated in a monolithic component.
